(19) United States
(12) Patent Application Publication
(10) Pub. No.: US 2005/0214637 A1
(43) Pub. Date: Sep. 29, 2005

(54) Battery separator and non-aqueous electrolyte secondary battery using the separator

(76) Inventors: Naoki Imachi, Kobe-city (JP); Seiji Yoshimura, Kobe-city (JP)

Correspondence Address: KUBOVCIK & KUBOVCIK, SUITE 710, 900 17TH STREET NW, WASHINGTON, DC, 20006, US

(21) Appl. No.: 11/091,368

(22) Filed: Mar. 29, 2005

(30) Foreign Application Priority Data
Mar. 29, 2004 (JP) 2004-093987

(51) Int. Cl. H01M 2/16

(52) U.S. Cl. 429/144; 429/62; 429/254

(57) ABSTRACT

A battery separator and a non-aqueous electrolyte battery using the separator are provided that are capable of achieving thickness reduction while fulfilling an insulating function, an electrolyte retention function, and a shutdown function. A battery separator, to be impregnated with a non-aqueous electrolyte and interposed between a positive electrode and a negative electrode, includes a structure of a plurality of layered microporous films, at least one of which includes a reinforcement film made of a polyolefin-based material, and at least one of the rest of which includes a heat-resistance film made of a material having a melting point of 200° C. or higher. The value obtained by multiplying separator thickness (μm) by separator porosity (%) is restricted to 792 μm·% or greater.

### BACKGROUND OF THE INVENTION

1. Field of the Invention

The present invention relates to an improvement in non-aqueous electrolyte secondary batteries, such as lithium-ion batteries and polymer batteries, and more particularly relates to a battery separator that has excellent heat resistance and is capable of obtaining good cycle performance even with high energy density batteries.

2. Description of Related Art

Rapid advancements in size and weight reductions of mobile information terminals such as mobile telephones, notebook computers, and PDAs in recent years have created a demand for higher capacity batteries as driving power sources for such devices. With their high energy density and high capacity, non-aqueous electrolyte batteries that perform charge and discharge by transferring lithium ions between the positive and negative electrodes are widely utilized as the driving power sources for such mobile information terminals as mentioned above.

As the mobile information terminals tend to require higher power consumption associated with an increased number of functions provided for the devices, further higher energy density is correspondingly required for non-aqueous electrolyte batteries. However, among the battery components, materials for the power-generating element (materials for positive and negative electrode active materials) have already been developed to reach almost the limit region of the energy that the materials can attain per se. For this reason, development of a novel power-generating element has been desired. Nevertheless, development of new high-energy materials for, for example, the positive electrode active material to be substituted for currently-used lithium cobalt oxide is delayed, and therefore it is difficult to expect a breakthrough of the current state in this respect. Consequently, size and weight reduction of the battery components, or higher filling density, is essential to achieve higher capacity in the batteries, and in particular, there is a great need for a thickness reduction of the components that are not directly involved in power generation, such as a battery can, separator, and current collector (positive electrode: Al foil, negative electrode: Cu foil). Although not directly involved in power generation, these components have a great influence on battery performance directly or indirectly Therefore, the influence on battery performance must be taken into careful consideration when thickness reduction of these components is considered.

Among the battery components that are not directly involved in power generation, a battery separator is a component the thickness and weight of which is difficult to reduce. In the following, recent developments of battery separators will be discussed.

First of all, it is necessary to prevent a battery separator from breaking when the separator is placed under tension during winding of the power-generating element including the separator. In addition to this, required functions of a battery separator include: an insulating function to reliably isolate positive and negative electrodes by the separator being inhibited from shrinking even when the battery is heated to a certain degree; an electrolyte retention function to accommodate non-aqueous electrolyte; a shutdown function to shut off electric current by clogging micropores at about 120° C. to 140° C. (i.e., a function to serve as a fuse); and so forth. In view of this, the development has mainly centered around olefin-based materials (usually low-melting point polyethylene is used taking the shutdown function into consideration).

Although the thickness reduction itself is easy with a separator made of olefin-based materials, other problems remain. For example, merely reducing the thickness leads to poor durability originating from thermal contraction, insufficiency of the insulating function, and degradation of the shutdown function due to breakage of the separator when tension is applied thereto. On the other hand, if the porosity of the separator is reduced with too much emphasis on strength, the electrolyte retention function becomes insufficient, leading to degradation in the battery performance such as the cycle performance.

In view of these problems, a battery separator has been proposed that comprises a porous substrate made of fiber or the like and a porous para-aramid polymer with which the substrate is coated (Japanese Published Unexamined Patent Application No. 10-324758).

However, without any modification, the battery separator according to the above-noted conventional technique is unable to realize the shutdown function because it utilizes fiber and/or pulp for the substrate. In order to impart the shutdown function to the separator with such a structure, it is necessary that a thermoplastic polymer be added to the separator, as is specifically mentioned in claim 2 of the publication. With such a structure, however, the shutdown response performance is dependent on the amount of the thermoplastic polymer. Moreover, the amount of the heat-resistant substance inevitably reduces when the separator thickness is reduced, making it difficult to ensure a desired heat resistance. It is believed that these are the reasons why examples in the above-noted publication disclose separators with considerably large thicknesses. As will be appreciated from this discussion, a problem with the conventional battery separators has been that they are unable to achieve thickness reduction while fulfilling the requirements of the insulating function, the electrolyte retention function, and the shutdown function.

### BRIEF SUMMARY OF THE INVENTION

Accordingly, it is an object of the present invention to provide a battery separator capable of achieving thickness reduction while fulfilling the insulating function, the electrolyte retention function, and the shutdown function, and a non-aqueous electrolyte battery using the separator.

In order to accomplish the foregoing and other objects, the present invention provides a battery separator to be impregnated with a non-aqueous electrolyte and interposed between a positive electrode and a negative electrode, the battery separator comprising: a plurality of layers of microporous films, at least one of the microporous films being a reinforcement film made of a polyolefin-based material, and at least one of the rest of the microporous film(s) being a film made of a material having a melting point of 200° C. or higher for providing heat resistance, wherein the value obtained by multiplying the thickness (μm) of the battery separator by the porosity (%) of the battery separator is 792 μm·% or greater.

### BRIEF DESCRIPTION OF THE DRAWINGS

FIG. 1 is a graph illustrating the cycle characteristics of Experimental Batteries P6, P7, and P11;

FIG. 2 is a graph illustrating the relationship between porosity and separator thickness when a polyethylene single-layer film is used as the separator; and

FIG. 3 is a graph illustrating the relationship between porosity and separator thickness when a two-layer structure of a polyethylene film and a polyamide film is used as the separator.

### DETAILED DESCRIPTION OF THE INVENTION

When a battery separator includes a film for strength comprising a polyolefin-based material and a film for heat resistance comprising a material having a melting point of 200° C. or higher as in the configuration described above, it is possible to complement the weaknesses of the strength film, which is inferior in heat resistance, and of the heat-resistance film, which is inferior in strength.

Specifically, since the separator includes a film which has good thermal stability, the separator can be prevented from causing thermal contraction. This means that, unlike the conventional separator, which is made of a single-layer polyolefin film that inevitably requires a low porosity in consideration of its heat resistance when thickness reduction is desired, the separator configured as described above does not necessitate a substantial reduction in the porosity of the film of a polyolefin-based material, because the heat resistance is ensured. In addition, because the separator includes a film made of a polyolefin-based material, which has large mechanical strengths such as tensile strength, the separator does not break easily during winding of the separator. This allows the heat-resistance film also to have a high porosity. Thus, the porosity (electrolyte accommodating property) of the separator as a whole can be made high while achieving thickness reduction of the separator, and consequently, battery cycle life can be improved.

For the reasons as stated above, the present invention can achieve separator thickness reduction while fulfilling the insulating function and the electrolyte retention function.

In addition, unlike the conventional battery separators, it is unnecessary to add a thermoplastic polymer separately since the film made of a polyolefin-based material itself can exhibit the shutdown function and, consequently, separator thickness reduction is achievable while fulfilling the shutdown function. Moreover, the use of a polyolefin-based material means that already-established know-how of polyolefin-based microporous films can be brought in, adding to the invention an advantage in terms of attaining sufficient battery performance.

Herein, the value obtained by multiplying the thickness (μm) of the battery separator by the porosity (%) of the separator is restricted to 792 μm·% or greater. The reason is that if the this value is less than 792 μm·%, the battery cannot fulfill 500 cycles of charge-discharge, which is currently required.

The melting point of the heat-resistance film is restricted to 200° C. or higher for the following reason. Specifically, when polyethylene is used for the reinforcement film, for example, the polyethylene melts at 120° C. to 140° C., but this is strictly the value inherent to the substance, under the situation where the temperature of the battery is elevated slowly. Under abnormal battery conditions, however, both overcharge characteristics and thermal characteristics of the battery often accompany an abrupt temperature increase, and under such conditions, the shutdown response offered by polyethylene is very slow. According to a test conducted by the present inventors, it was confirmed that at a temperature elevation rate of 2° C./min., the shutdown at 120° C. to 140° C., the inherent range of the material, was possible, but at a temperature elevation rate of 20° C./min., the response (shutdown) was not obtained unless the temperature became 160° C. or higher. From these results, it is understood that the heat-resistance film is required to have a thermal stability that can sufficiently withstand even a temperature in the vicinity of 160° C. to 170° C. under a situation in which the higher temperature elevation rate is even higher, and therefore, the melting point of the film is restricted to 200° C. or higher.

In the battery separator of the present invention, the thickness of the heat-resistance film is preferably 3 μm or greater but less than 10 μm.

The reason for this restriction is as follows. If the thickness of the heat-resistance film is less than 3 μm, thermal contraction of the separator may not be prevented completely, whereas if the thickness of the film is 10 μm or greater, a problem may arise that curling develops in the film, which has lower ductility, due to the difference in elasticity between it and the reinforcement film.

In the battery separator of the present invention, the thickness of the battery separator is preferably 12 μm or greater.

The reason for this restriction is that if the thickness of the battery separator is less than 12 μm, the electrolyte accommodating rate may become less than 792 μm·% and consequently there is a risk of degradation in cycle performance.

In the battery separator of the present invention, the thickness of the battery separator is preferably 18 μm or less.

The reason for this restriction is that if the thickness of the battery separator exceeds 18 μm, a sufficient electrolyte accommodating rate can be obtained even with the conventional polyethylene separator, which means that thickness reduction of the separator, which is a primary object of the present invention, cannot be attained. Nevertheless, the electrolyte accommodating rate of the separator achieved by the present invention aims at such a target that the electrolyte dry-out does not occur up to 500 cycles, so in cases where a greater number of charge-discharge cycles is required before the electrolyte dry-out occurs, the thickness of the battery separator needs to be 18 μm or greater.

In the battery separator of the present invention, the heat-resistance film is preferably made of a polyamide or a polyimide.

The reason for this restriction is that the polyamide or the like has a melting point or 200° C. or higher and therefore it can sufficiently offer the advantages attainable by the present invention.

In the above-noted battery separator of the present invention, the polyamide may be a para-aromatic polyamide.

The reason for this restriction is that the para-aromatic polyamide shows very little strength deterioration up to 200° C. and tends to be excellent in heat resistance among polyamides. Moreover, since the para-aromatic polyamide is generally said to have a self-extinguishing function, there is an additional advantage that a flame-retarding feature can be imparted in case the battery catches fire.

In the battery separator of the present invention, the reinforcement film is preferably made of polyethylene.

The reason for this restriction is that since the melting point of polyethylene is low, 120° C. to 140° C., it is capable of clogging the pores in the separator at a low temperature, offering the shutdown function in a safer way.

In the present invention, the battery separator preferably comprises a three-layer structure in which a layer of the heat-resistance film is interposed between two layers of the reinforcement film.

The reason why such a structure is adopted is as follows. Specifically, the heat-resistance film has a problem of high friction as a material property, by which the power-generating element does not easily come off from the center pin in winding electrodes. This problem can be resolved by disposing one heat-resistance film between two reinforcement films so that the heat-resistance film is sandwiched by the reinforcement films. Consequently, the battery productivity can be improved and the risk of causing curling or the like can be reduced by sandwiching the heat-resistance film by the reinforcement films.

In order to accomplish the foregoing and other objects, the present invention also provides a non-aqueous electrolyte secondary battery comprising a positive electrode having a positive electrode active material, a negative electrode having a negative electrode active material, and a battery separator interposed between the positive electrode and the negative electrode, wherein the battery separator comprises a plurality of layers of microporous films, at least one of the microporous films being a reinforcement film made of a polyolefin-based material, and at least one microporous film of the remaining microporous film(s) being a heat-resistance film made of a material having a melting point of 200° C. or higher, and wherein the value obtained by multiplying the thickness (μm) of the battery separator by the porosity (%) of the battery separator is 792 μm·% or greater.

In the non-aqueous secondary battery of the present invention, the thickness of the heat-resistance film is preferably 3 μm or greater but less than 10 μm.

In the non-aqueous secondary battery of the present invention, the thickness of the battery separator is preferably 12 μm or greater.

In the non-aqueous secondary battery of the present invention, the thickness of the battery separator is preferably 18 μm or less.

In the non-aqueous secondary battery of the present invention, the heat-resistance film is preferably made of a polyamide or a polyimide.

In the above-noted non-aqueous secondary battery of the present invention, the polyamide is preferably a para-aromatic polyamide.

In the non-aqueous secondary battery of the present invention, the reinforcement film is preferably made of polyethylene.

In the non-aqueous secondary battery of the present invention, the battery separator preferably comprises a three-layer structure in which a layer of the heat-resistance film is interposed between two layers of the reinforcement film.

In the non-aqueous secondary battery of the present invention, the positive electrode active material preferably contains a lithium cobalt oxide or a lithium-nickel composite oxide, and the negative electrode active material preferably contains a carbon material.

The reason for this restriction is that the advantages of the present invention are thereby exhibited more effectively since the dry-out tends to occur more readily as charge-discharge cycles are repeated particularly when a lithium cobalt oxide or a lithium-nickel composite oxide is contained as the positive electrode active material and a carbon material is contained as the negative electrode active material.

The present invention achieves such advantages that separator thickness reduction can be attained while fulfilling the required functions for a separator including the insulating function, the electrolyte retention function, and the shutdown function.

### DESCRIPTION OF THE PREFERRED EMBODIMENTS

Hereinbelow, the present invention is described in further detail. It should be understood, however, that the present invention is not limited to the following preferred embodiments but various changes and modifications are possible without departing from the scope of the invention as defined in the appended claims.

Preparation of Positive Electrode

First, lithium cobalt oxide, used as a positive electrode active material, and SP300 made by Nippon Graphite Industries, Ltd. and acetylene black, as carbon conductive agents, were mixed together at a mass ratio of 92:3:2 to prepare a positive electrode mixture powder. Next, 200 g of the powder was charged into a mixer (for example, a mechanofusion system AM-15F made by Hosokawa Micron Corp.), and the mixer was operated at a rate of 1500 rpm for 10 minutes to cause compression, shock, and shear actions while mixing, to prepare a positive electrode active material mixture. Subsequently, the prepared positive electrode active material mixture and a fluoropolymer-based binder agent (PVDF) were mixed at a mass ratio of 97:3 in NMP solvent to prepare a positive electrode slurry. Thereafter, the positive electrode slurry was applied on both surfaces of an aluminum foil serving as a positive electrode current collector, and the resultant material was then dried and rolled. Thus, a positive electrode was prepared.

It should be noted that, in order to clearly show the effect caused when a battery is made to have a high capacity in the tests in the later-described examples, the amount of the positive electrode slurry applied on both surfaces of the current collector was set at 546 mg/10 cm² (the weight of the positive electrode current collector not included) and the filling density was regulated to 3.57 g/cc.

Preparation of Negative Electrode

A carbon material (graphite), CMC (carboxymethylcellulose sodium), and SBR (styrene-butadiene rubber) were mixed in an aqueous solution at a mass ratio of 98:1:1 to prepare a negative electrode slurry. Thereafter, the negative electrode slurry was applied on both surfaces of a copper foil serving as a negative electrode current collector, and the resultant material was then dried and rolled. Thus, a negative electrode was prepared.

It should be noted that, in order to clearly show the effect caused when a battery is made to have a high capacity in the test in the later-described examples, the amount of the negative electrode slurry applied to both surfaces was set at 240 mg/10 cm² (the weight of the negative electrode current collector not included) and the filling density was regulated to be 1.70 g/cc.

Here, the above-noted amounts of the positive electrode slurry and the negative electrode slurry applied are believed to be the limit values with which the slurries can be applied on the positive and negative electrodes while taking bending characteristics of the positive and negative electrodes into consideration and preventing electrode breakage during winding and pressing of the power-generating element containing the positive and negative electrodes.

Preparation of Non-Aqueous Electrolyte Solution

LiPF₆ was dissolved at a concentration of 1.0 mole/L in a mixed solvent of 3:7 volume ratio of ethylene carbonate (EC) and diethyl carbonate (DEC) to prepare a non-aqueous electrolyte solution.

Preparation of Separator

First, polyamide, which is a water-insoluble heat-resistant material, was dissolved at a concentration of 1 mole/L in a N-methyl-2-pyrrolidone (NMP) solution, which is a water-soluble solvent, and the resultant solvent was coated on one side of a microporous polyethylene (PE) film serving as a substrate to a predetermined thickness. Next, the coated polyethylene film was immersed into water to remove the water-soluble NMP solvent and precipitate/solidify the water-insoluble polyamide. Thereby, a microporous polyamide film was formed on one side of the polyethylene film. Thereafter, water was removed by drying the film at a temperature lower than the melting point of polyethylene (at 80° C., for example). Thus, a separator comprising layered microporous films, which was the target product, was obtained.

Assembling of Battery

Leads were attached to the positive and negative electrodes, respectively, and the positive and negative electrodes with the separator interposed therebetween were wound in a spiral form. The wound electrodes were then pressed into a flat shape to prepare a power-generating element, and thereafter, the power-generating element was accommodated into an aluminum laminate film serving as a battery case. Then, the non-aqueous electrolyte solution was filled into the space, and thereafter the battery case was sealed by welding the aluminum laminate film. Thus, a battery was fabricated.

The design capacity of the battery, which was calculated from the amount of the active materials applied onto the positive and negative electrodes, was 880 mAh.

Other Variations

(1) In the above-described embodiment, the separator forms a two-layer structure of a reinforcement film (polyethylene film) and a heat-resistance film (polyamide film). However, the heat-resistance film has high friction originating from its material properties and therefore tends to cause a problem that the power-generating element does not easily come off from the center pin during the winding of the electrodes. Although, even with the two-layer film as in the foregoing embodiment, the problem does not arise when the heat-resistance film is placed on the outer surface, it is preferable that the separator be formed of a three-layer structure of reinforcement film/heat-resistance film/reinforcement film in order to ensure stable productivity and reduce the risk of development of a curl or the like.

(2) In the foregoing embodiment, para-aromatic polyamide was used as the material for the heat-resistance film; however, the material for the heat-resistance film is not limited, and other polyamides, polyimides, or materials having a similar conformation and structure such as ortho- and meta-polyamide may be used. The reason is that these substances also have a melting point of 200° C. or higher and their porosity can be set to as high as about 80%.

(3) The water-soluble solvent is not limited to N-methyl-2-pyrrolidone but other solvents such as N,N-dimethylformamide and N,N-dimethylacetamide may also be employed. The number and size of micropores can be controlled by adjusting the concentration of the heat-resistance material in the water-soluble solvent.

(4) The method for mixing the positive electrode mixture is not limited to the above-noted mechanofusion method. Other possible methods include a method in which a mixture is dry-blended while milling the mixture with a Raikai-mortar, and a method in which the mixture is wet-mixed and dispersed directly in a slurry.

(5) The positive electrode active material is not limited to a lithium cobalt oxide as described above. Other usable materials include lithium-nickel composite oxides represented by lithium nickel oxide, lithium-manganese composite oxides represented by spinel-type lithium manganese oxide, and olivine-type phosphate compounds.

(6) The negative electrode active material is not limited to graphite, and various other materials may be employed, such as coke, tin oxides, metallic lithium, silicon, and mixtures thereof, as long as the materials are capable of intercalating and deintercalating lithium ions.

(7) The lithium salt in the electrolyte solution is not limited to LiPF₆, and various other substances may be used, including LiBF₄, LiN(SO₂CF₃)₂, LiN(SO₂C₂F₅)₂, LiPF_{6-X}(CnF₂ₙ₊₁)_{X} (wherein 1<x<6 and n=1 or 2), which may be used either alone or in a combination of two or more of them. The concentration of the lithium salt is not particularly limited, but it is preferable that the concentration of the lithium salt be restricted in the range of from 0.8 moles to 1.5 moles per 1 liter of the electrolyte solution. The solvents for the electrolyte solution are not particularly limited to ethylene carbonate (EC) and diethyl carbonate (DEC) as mentioned above, and preferable solvents include carbonate solvents such as propylene carbonate (PC), γ-butyrolactone (GBL), ethyl methyl carbonate (EMC), and dimethyl carbonate (DMC). More preferable is a combination of a cyclic carbonate and a chain carbonate.

(8) The present invention is not limited to liquid-type batteries but may be applied to gel-type polymer batteries. When this is the case, examples of the polymer material include polyether-based solid polymer, polycarbonate solid polymer, polyacrylonitrile-based solid polymer, oxetane-based polymer, epoxy-based polymer, and copolymers or cross-linked polymers comprising two or more of these polymers, as well as PVDF. A gelled solid electrolyte in which any of these polymer materials, a lithium salt, and an electrolyte are combined may be used.

### EXAMPLES

Preliminary Experiment

Experimental Batteries 1 to 16

Batteries were prepared in the same manner as in the foregoing embodiment except that, in each of the batteries, the separator was made of a polyethylene single-layer film and the thickness and porosity of each separator was changed as set forth in Tables 1 to 3 below. The batteries thus prepared are hereinafter referred to as Experimental Batteries P1 to P16.

It should be noted that the porosity of each of the separators was measured as follows. The same method of the measurement was adopted throughout the following experiments.

Measurement of Separator Porosity

Each of the films to be used as the separators was cut into a 10 cm×10 cm square, and the mass (W g) and the thickness (D cm) of each sample were measured. The mass of a material within the sample was determined by calculation, then the mass of the material [Wi(i=1 to n)] was divided by the absolute specific gravity, to estimate the volume of the material. Then, the porosity (volume %) was determined according to Equation 1 below.
Porosity (%)=100−{(W1/absolute specific gravity 1)+(W2/absolute specific gravity 2)+ . . . +(Wn/absolute specific gravity n)}×100/(100*D) Eq. 1.
Experiment 1

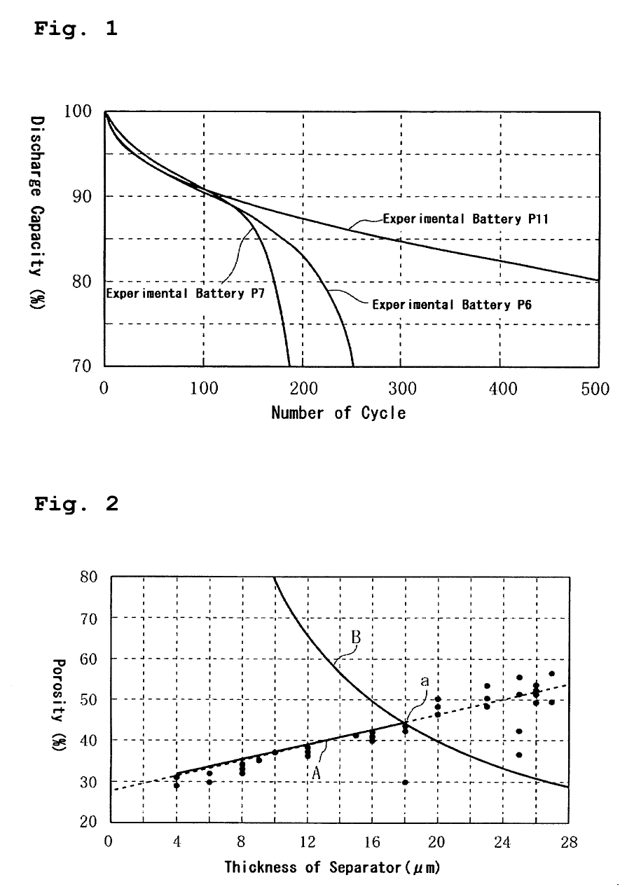

Experiment 1 examines the relationship between the physical properties (electrolyte accommodating rate) of the separator and cycle life. Specifically, Experimental Batteries P1 to P16 were charged and discharged for 500 cycles under the following charge-discharge conditions (temperature: 25° C.) to examine the cycle life (about whether an electrolyte dry-out occurred and an approximate number of cycles at which cycle life degradation occurred due to the electrolyte dry-out) of each of the batteries. The results are collectively shown in Tables 1 to 3. As for Experimental Batteries P6, P7, and P11, the relationship between number of cycles and discharge capacity was also examined. The results are shown in FIG. 1.

Charge-Discharge Conditions

Charge Conditions

Each of the batteries was charged at a constant current of 1C (850 mA) to 4.2 V and charged at a constant voltage 4.2 V to a current of C/20 (42.5 mA).

Discharge Test

Each of the batteries was discharged at a constant current of 1C (850 mA) to 2.75 V.

Interval

The interval between charge and discharge was 10 minutes.

TABLE 1

| | Exp. | Exp. | Exp. | Exp. | Exp. | Exp. |
|---|---|---|---|---|---|---|
| | Battery | Battery | Battery | Battery | Battery | Battery |
| | P1 | P2 | P3 | P6 | P5 | p6 |
| Separator | 5 | 5 | 8 | 8 | 12 | 12 |
| thickness | | | | | | |
| (μm) | | | | | | |
| Porosity (%) | 30 | 42 | 33 | 45 | 36 | 50 |
| Electrolyte | 150 | 210 | 264 | 360 | 432 | 600 |
| accommodating | | | | | | |
| rate (μm · %) | | | | | | |
| Electrolyte | Yes | Yes | Yes | Yes | Yes | Yes |
| dry-out | | | | | | |
| *See remarks | 30 | 40 | 50 | 80 | 90 | 180 |

*The values in the bottom line indicate approximate numbers of cycles at which cycle life deterioration has occurred due to electrolyte dry-out.

TABLE 2

| | Exp. | Exp. | Exp. | Exp. | Exp. | Exp. |
|---|---|---|---|---|---|---|
| | Battery | Battery | Battery | Battery | Battery | Battery |
| | P7 | P8 | P9 | P10 | P11 | P12 |
| Separator | 18 | 18 | 18 | 18 | 18 | 18 |
| thickness | | | | | | |
| (μm) | | | | | | |
| Porosity (%) | 30 | 35 | 40 | 43 | 44 | 50 |
| Electrolyte | 540 | 630 | 720 | 774 | 792 | 900 |
| accommodating | | | | | | |
| rate (μm · %) | | | | | | |
| Electrolyte | Yes | Yes | Yes | Yes | No | No |
| dry-out | | | | | | |
| *See remarks | 140 | 160 | 340 | 420 | — | — |

*The values in the bottom line indicate approximate numbers of cycles at which cycle life deterioration has occurred due to electrolyte dry-out.

TABLE 3

| | Exp. | Exp. | Exp. | Exp. |
|---|---|---|---|---|
| | Battery | Battery | Battery | Battery |
| | P13 | P14 | P15 | P16 |
| Separator thickness (μm) | 20 | 20 | 25 | 25 |
| Porosity (%) | 40 | 48 | 36 | 55 |
| Electrolyte | 800 | 960 | 900 | 1375 |
| accommodating rate (μm · %) | | | | |
| Electrolyte dry-out | No | No | No | No |
| *See remarks | — | — | — | — |

*The values in the bottom line indicate approximate numbers of cycles at which cycle life deterioration has occurred due to electrolyte dry-out.

FIG. 1 and Tables 1 to 3 clearly demonstrate that some of the batteries achieved a cycle life of 500 cycles or greater but some of them did not. According to a study conducted by the present inventors, it was found that such a difference originated from the amounts of the electrolyte solution within the separators. It should be noted here that the amount of electrolyte solution in a separator can be generally estimated by electrolyte accommodating rate=separator thickness (μm)×separator porosity (%).

Here, a discussion is given as to why cycle life varies depending on the amount of the electrolyte solution in the separator. Many of the materials for lithium-ion batteries undergo expansion and contraction during repeated cycles due to the intercalation and deintercalation of lithium ions, which accompanies absorption and desorption of the electrolyte solution that also take place during repeated cycles. While this is taking place, a reaction that consumes (decomposes) the electrolyte solution also occurs as a side reaction at the same time, causing shortage of the electrolyte solution in a late stage of cycle tests. Consequently, the drying-out of the electrolyte solution (hereafter referred to as a “dry-out”) occurs as observed with Experimental Batteries P6 and P7 as shown in FIG. 1, often causing a phenomenon in which the battery capacity rapidly decreases. This phenomenon can be avoided by increasing the porosity of the separator, but as well as the function to accommodate a predetermined amount of electrolyte solution, there are other features that the separator needs to fulfill, such as prevention of thermal contraction of the separator when the battery temperature becomes high and to prevent separator breakage when winding the power-generating element. In order to fulfill such functions, the porosity needs to be rather lowered. For this reason, there is a limitation in increasing the porosity of the separator made of polyethylene, especially with thin-type separators.

As a result of various studies conducted by the present inventors, it was found that the electrolyte accommodating rate of a separator needs to be about 792 μm·% or greater in order to attain satisfactory cycle performance without causing the dry-out of electrolyte solution, as will be clearly appreciated from Tables 1 to 3 above. This condition is equivalent to the use of a separator made of polyethylene having a thickness of 18 μm and a porosity of 44%. In the range that is below the above-stated electrolyte accommodating rate, the number of cycles before the dry-out and the amount of electrolyte retained do not show a clear proportional relationship although the number of cycles until the dry-out shows an increasing tendency as the amount of electrolyte retained increases. It was confirmed that the dry-out phenomenon did not occur with the batteries using a separator having an electrolyte accommodating rate of 792 μm·% or greater.

Although the dry-out phenomenon over cycles is also dependent on the amount of electrode materials applied, those amounts of the electrode materials applied that were employed herein are believed to be almost the limit values taking into consideration bending characteristics of the separator and the problem of electrode breakage during winding and pressing of the electrodes, as already discussed previously. Therefore, it is believed that if the dry-out phenomenon does not take place with the batteries fabricated herein, the dry-out phenomenon will also not occur with other batteries within the range of 500 cycles, which is required for the batteries with other specifications.

The electrolyte accommodating rate 792 μm·% or greater of a separator is not the required value particularly of the separator made of polyethylene, but it is also applicable to other separators (later-described composite separators).

Experiment 2

Experiment 2 examined the conditions necessary to pass the thermal test for batteries specified by the UL standard. Specifically, in the measurement of thermal contraction of a separator as described in the following, it is desirable that a separator shows a thermal contraction of 20% or lower after the separator has been kept at 120° C. for 10 minutes.

Measurement of Separator Thermal Contraction

Each of test pieces of separators (5 cm×2 cm) was placed between slide glasses, and both ends of the glasses were fixed with clips. The test pieces were retained for 10 minutes at various temperatures to obtain percentage of shrinkage.

The results indicated that when the thickness of the separator exceeded 18 μm, the anti-thermal contraction performance can be ensured corresponding to the necessary strength (corresponding to the later-described thermal test) because of the thickness, so the porosity can be relatively freely set even if the separator is formed of a polyethylene single layer. On the other hand, when the thickness is reduced, the porosity cannot be made large because the heat-resistant performance needs to be maintained. Accordingly, with a separator made of a single layer of polyethylene, it is impossible to achieve a large porosity using a thin-type separator while maintaining heat resistance. To suppress thermal contraction, it may be conceivable to employ a method of ensuring close contact between the electrodes and the separator using a polymer material, but even with such a method, it is very unlikely to achieve a porosity of from 70% to 90% with a separator made of polyethylene. Since it is necessary to ensure such a strength that can withstand winding, it is believed that the upper limit of the porosity of a separator made of polyethylene alone is about 60%.

Summary of Experiments 1 and 2

The results of Experiments 1 and 2 are summarized in FIG. 2. The correlation between thickness and porosity was obtained from the results of evaluation of the samples with varied porosities at each of respective thicknesses according to the upper limit values at which necessary heat resistance can be ensured (solid line A). In addition, the required porosities at respective thicknesses were also calculated that could enable the separator to have an electrolyte accommodating rate of 792 μm·%, which can serve as a guideline to indicate a dry-out of electrolyte solution (solid line B). It should be noted that, in FIG. 2, the porosity of a separator needs to be regulated below the solid line A in order to ensure the heat resistance of the separator, while the porosity needs to be regulated above the solid line B in order to ensure the electrolyte accommodating rate of the separator.

As clearly seen from FIG. 2, in a region below 18 μm (leftward of Point a), the porosity must be lowered to ensure the heat resistance. On the other hand, to obtain a desirable electrolyte accommodating rate, the required porosities at respective separator thicknesses are about 50% at a thickness of 16 μm, about 66% at 12 μm, and about 79% at 10 μm. These results demonstrate that a separator made of polyethylene that fulfils both requirements cannot be produced in the region of 18 μm or less (leftward of Point a).

Although it may be possible to improve heat resistance using a material with high thermal stability, such as polypropylene (PP, melting point: about 160° C. to 180° C.), a certain amount of polyethylene material is essential to ensure the shutdown function, which is necessary for a separator. Moreover, even if other olefin-based materials are used, the heat resistance cannot be increased as much as desired, and furthermore, it is difficult to increase the porosity. Therefore, a separator with a thickness of 18 μm and a high porosity cannot be fabricated without using a hybrid-type highly heat-resistant material mainly composed of polyethylene.

### First Embodiment

### Examples A1 to A5

Batteries were fabricated in the same manner as in the foregoing embodiment except that the thickness of polyethylene (PE) film, which is the reinforcement film, was 4 μm and the thickness of the para-aromatic polyamide (PA) film, which is the heat-resistance film, was changed. The thickness of the polyethylene film, which is the reinforcement film, was set at 4 μm to examine whether the heat-resistance film can complement the reinforcement film even when the reinforcement film has a large thermal contraction. Also, the heat-resistance film used here was controlled to have a porosity of 80%, which was the highest value among those optimized herein, for the purpose of maximizing the electrolyte accommodating rate.

The batteries thus prepared are hereinafter referred to as Batteries A1 to A5 of the invention.

### Comparative Examples X1 to X3

Batteries were fabricated in the same manner as in Examples A1 to A5 except that a polyethylene single-layer film was used as the separator and the thickness and porosity of the separator were changed as set forth in Table 5.

The batteries thus prepared are hereinafter referred to as Comparative Batteries X1 to X3.

Experiment

The thermal contraction ratios of Batteries A1 to A5 of the invention and Comparative Batteries X1 to X3 were examined. The results are shown in Tables 4 and 5 below. The conditions in the experiment were identical to the conditions in Experiment 2 in the Preliminary Experiment discussed above except that the temperatures were changed.

TABLE 4

| | | Battery | Battery | Battery | Battery | Battery |
|---|---|---|---|---|---|---|
| | | A1 | A2 | A3 | A4 | A5 |
| Separator material | | PE/PA | PE/PA | PE/PA | PE/PA | PE/PA |
| Separator thickness | | 38442 | 38444 | 38446 | 38451 | 38456 |
| (μm) | | | | | | |
| Porosity (%) | | 40 | 52 | 58 | 66 | 70 |
| Shrinkage (%) | 120° C. | 20.5 | 0.1 | 0 | 0 | 0 |
| | 130° C. | 25.1 | 0.1 | 0 | 0 | 0 |
| | 140° C. | 27.3 | 0.2 | 0 | 0 | 0 |
| | 150° C. | 29.4 | 0.2 | 0 | 0 | 0 |

| | | | | | |
|---|---|---|---|---|---|
| Curl/Cracks | No | No | No | Slight | Cracks |
| | | | | curl | |

TABLE 5

| | | Comp. | Comp. | Comp. |
|---|---|---|---|---|
| | | Battery | Battery | Battery |
| | | X1 | X2 | X3 |
| Separator material | | PE | PE | PE |
| Separator thickness (μm) | | 4 | 10 | 20 |
| Porosity (%) | | 31 | 37 | 48 |
| Shrinkage (%) | 120° C. | 25.6 | 20.0 | 17.0 |
| | 130° C. | 34.2 | 32.4 | 31.2 |
| | 140° C. | 34.8 | 32.9 | 32.5 |
| | 150° C. | 35.4 | 33.3 | 33.4 |

| | | | |
|---|---|---|---|
| Curl/Cracks | No | No | No |

Tables 4 and 5 clearly demonstrate that Batteries A1 to A5 of the invention, in which the heat-resistance film (para-aromatic polyamide film) existed, showed less thermal contraction of the separators than Comparative Batteries X1 to X3, in which the heat-resistance film did not exist. Particularly with Batteries A2 to A5 of the invention, in which the thickness of the heat-resistance film was 3 μm or greater, thermal contraction of the separator was prevented almost completely. Batteries A4 and A5 of the invention, in which the thickness of the heat-resistance film was 10 μm or greater, however, tended to develop curling or cracks in the heat-resistance film, which is low in ductility, because of the difference in elasticity between the materials of the heat-resistance film and the reinforcement film. Battery A1 of the invention, in which the thickness of the heat-resistance film is less than 3 μm, could prevent thermal contraction of the separator only to a certain degree.

Accordingly, it is understood that the thickness of the heat-resistance film should preferably be 3 μm or greater but less than 10 μm in order to almost completely prevent thermal contraction with additional considerations in terms of strength, such as increasing productivity in winding electrodes or preventing cracks in the separator.

### Second Embodiment

Polyamides and polyimides are excellent materials for the heat-resistance film in the present invention in that they have good heat resistance and the porosity can be set as high as about 80% when polyethylene is used as a substrate to complement the weakness in strength such as ductility. In view of this, batteries as illustrated in the following were fabricated to examine cycle performance and development of curling in the separators.

### Examples B1 to B10

Batteries were fabricated in the same manner as in the foregoing embodiment except that the electrolyte accommodating rate was varied by changing the thickness and porosity of the separator and that the thickness of the polyethylene (PE) film and the thickness of the polyamide (PA) film were changed.

The batteries thus prepared are hereinafter referred to as Batteries B1 to B10 of the invention.

The porosity of the polyamide film was set to be close to the limit value 80%, while the porosity of the polyethylene film was adjusted to be close to the threshold value 60%, taking the mechanical strengths (tensile strength, etc.) into account. The specific reason why the porosity of the polyethylene film was restricted to 60% was as follows.

A separator needs to have a certain degree of tensile strength because it is placed under a tension when winding the power-generating element. In this case, a separator with a high porosity is easy to break and therefore tends to cause a problem in terms of productivity. On the other hand, a separator with a thickness of 4 μm or less cannot maintain its strength when it is made into a microporous film. In view of these problems, a 4 μm-thick polyethylene film was used as a substrate, while the porosity of the polyethylene film was restricted to 60% or less in this test. It was confirmed that polyethylene films thus controlled did not break during the production of batteries.

### Comparative Examples Y1 to Y6

Batteries were fabricated in the same manner as in Examples B1 to B10 except that the electrolyte accommodating rates were varied by changing the thickness and porosity of separators and that the thickness of the polyethylene film and the thickness of the polyamide film were changed.

The batteries thus prepared are hereinafter referred to as Comparative Batteries Y1 to Y6, respectively.

Experiment

A charge-discharge cycle test was conducted for Batteries B1 to B10 of the invention and Comparative Batteries Y1 to Y6 to examine the cycle life (whether electrolyte dry-out occurred and an approximate number of cycles at which cycle life degradation occurred due to the electrolyte dry-out) of each battery and development of curling in the separator. The results are shown in Tables 6 to 8 below. The charge-discharge conditions were identical to the conditions in Experiment 1 in Preliminary Experiment discussed above.

TABLE 6

| | Battery | Battery | Battery | Battery | Battery | Battery |
|---|---|---|---|---|---|---|
| | B1 | B2 | B3 | B4 | B5 | B6 |
| Separator | 12 | 12 | 12 | 12 | 12 | 14 |
| thickness | | | | | | |
| (μm) | | | | | | |
| Porosity (%) | 73 | 70 | 70 | 68 | 66 | 65 |
| Electrolyte | 876 | 840 | 840 | 816 | 792 | 910 |
| accommodating | | | | | | |
| rate (μm · %) | | | | | | |
| Thickness of | 4 | 5 | 6 | 7 | 8 | 10 |
| PE film (μm) | | | | | | |
| Thickness of | 8 | 7 | 6 | 5 | 4 | 4 |
| PA film (μm) | | | | | | |
| Electrolyte | No | No | No | No | No | No |
| dry-out | | | | | | |
| Curl | Yes | Yes | Yes | No | No | No |
| *See remarks | — | — | — | — | — | — |

*The values in the bottom line indicate approximate numbers of cycles at which cycle life deterioration has occurred due to electrolyte dry-out.

TABLE 7

| | Battery | Battery | Battery | Battery |
|---|---|---|---|---|
| | B7 | B8 | B9 | B10 |
| Separator thickness (μm) | 16 | 18 | 18 | 20 |
| Porosity (%) | 66 | 66 | 70 | 58 |
| Electrolyte accommodating rate | 1056 | 1188 | 1260 | 1160 |
| (μm · %) | | | | |
| Thickness of PE film (μm) | 11 | 12 | 9 | 14 |
| Thickness of PA film (μm) | 5 | 6 | 9 | 6 |
| Electrolyte dry-out | No | No | No | No |
| Curl | No | No | No | No |
| *See remarks | — | — | — | — |

*The values in the bottom line indicate approximate numbers of cycles at which cycle life deterioration has occurred due to electrolyte dry-out.

TABLE 8

| | Comp. | Comp. | Comp. | Comp. | Comp. | Comp. |
|---|---|---|---|---|---|---|
| | Battery | Battery | Battery | Battery | Battery | Battery |
| | Y1 | Y2 | Y3 | Y4 | Y5 | Y6 |
| Separator | 7 | 8 | 9 | 10 | 10 | 11 |
| thickness | | | | | | |
| (μm) | | | | | | |
| Porosity (%) | 40 | 47 | 53 | 60 | 58 | 65 |
| Electrolyte | 280 | 376 | 477 | 600 | 580 | 715 |
| accommodating | | | | | | |
| rate (μm · %) | | | | | | |
| Thickness of | 4 | 4 | 4 | 4 | 5 | 5 |
| PE film (μm) | | | | | | |
| Thickness of | 3 | 4 | 5 | 6 | 5 | 6 |
| PA film (μm) | | | | | | |
| Electrolyte | Yes | Yes | Yes | Yes | Yes | Yes |
| dry-out | | | | | | |
| Curl | Yes | Yes | Yes | Yes | Yes | Yes |
| *See remarks | 60 | 110 | 130 | 280 | 270 | 410 |

*The values in the bottom line indicate approximate numbers of cycles at which cycle life deterioratian has occurred due to electrolyte dry-out.

Tables 6 to 8 clearly demonstrate that Comparative Batteries Y1 to Y6 caused an electrolyte dry-out at cycle 500 or earlier and the cycle life expired, while Batteries B1 to B10 of the invention did not cause an electrolyte dry-out even after cycle 500 and the cycle life did not expire. It is believed that the results are due to the fact that all of Batteries B1 to B10 of the invention, in which the separator thickness is 12 μm or greater, have an electrolyte accommodating rate of 792 μm·% or greater, while all of Comparative Batteries Y1 to Y6, in which the separator thickness is less than 12 μm, have an electrolyte accommodating rate of less than 792 μm·%. Therefore, it will be appreciated that the thickness of the separator needs to be 12 μm or greater, taking cycle performance into consideration.

Moreover, because separators that have a polyamide film (heat-resistance film) with a larger thickness tend to show a larger porosity of the film as a whole even if the separators have the same thickness (for example, when comparing Battery B1 of the invention with Battery B5 of the invention, Battery B1 of the invention, which has a higher proportion of polyamide film, has a higher porosity and an increased electrolyte accommodating rate), it may appear that the polyamide film should have a greater thickness. Nevertheless, if the thickness of the polyamide film is increased, the thickness of the polyethylene film is relatively reduced, causing the strength of the separator as a whole to become poorer. In particular, in the smaller separator thickness region, most of the separators developed a curl when the polyamide film is thicker than the polyethylene film (cf. Batteries B1 to B3 of the invention). The results empirically indicate that it is preferable that the thickness ratio of the polyethylene film (reinforcement film) and the polyamide film (heat-resistance film) be controlled to about 2:1 in a small separator thickness region, and within this range of the ratio, it is possible to produce separators free from curl with high productivity.

It was also confirmed that all the above-noted separators showed about 0% of shrinkage at 120° C. and there was no problem in terms of anti-thermal contraction performance.

Relationship Between Separator Thickness and Separator Porosity

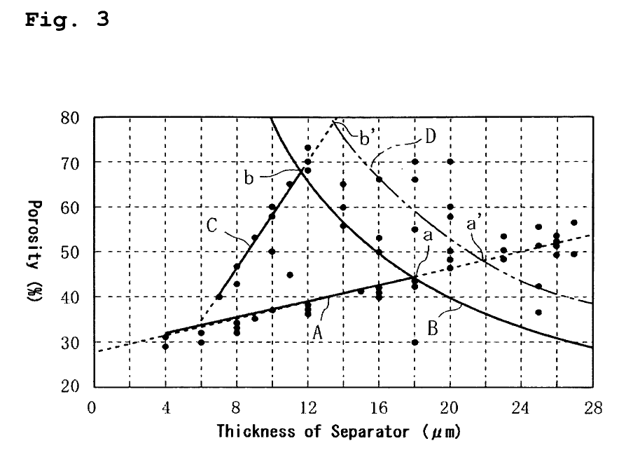

The relationship between separator thickness and separator porosity was investigated using Batteries B1 to B10 of the invention and Comparative Batteries Y1 to Y6 as well as various other batteries having different thicknesses and porosities from Batteries B1 to B10 and Comparative Batteries Y1 to Y6. The results are shown in FIG. 3. The correlation between thickness and porosity was obtained from the results of evaluation of the samples with varied porosities at each of respective thicknesses to match the upper limit values at which necessary heat resistance can be ensured (solid line C). In addition, the required porosities at respective thicknesses were also calculated that could enable the separator to have an electrolyte accommodating rate of 792 μm·%, which can serve as a guideline to indicate a dry-out of electrolyte solution (same as solid line B in FIG. 2 that was previously discussed). The correlation between thickness and porosity with separators made of only polyethylene is also shown (same as solid line A in FIG. 2 that was previously discussed).

FIG. 3 clearly demonstrates that the batteries using the separator made of a polyamide/polyethylene composite film (solid line C) were capable of improving the porosity remarkably while maintaining the heat resistance irrespective of the separator thickness, over the batteries using the separator made of a conventional polyethylene single-layer film (solid line A), and consequently showed increased electrolyte accommodating rate in the separator. It should be noted, however, that in the region in which the thickness of the separator is less than 12 μm (leftward of Point b), the dry-out phenomenon occurred within 500 cycles because the electrolyte accommodating rate was not 792 μm·% or greater even with the batteries using the separator made of a polyamide/polyethylene composite film. Thus, it is understood that with a battery using a separator made of a polyamide/polyethylene composite film, the thickness of the separator should desirably be 12 μm or greater.

On the other hand, when the thickness of the separator exceeds 18 μm (rightward of Point a), the electrolyte accommodating rate can be set at 792 μm·% or greater even with the conventional separator made of a polyethylene single-layer film, and therefore, it is difficult to find advantages from the viewpoint of thickness reduction in the separator. Accordingly, it will be appreciated that the thickness of the separator should desirably be 18 μm or less in order to utilize the characteristics of the separator made of a polyamide/polyethylene composite film.

Herein, the electrolyte accommodating rate of a separator is regulated to be 792 μm·% or greater because the standard charge-discharge cycle number of a battery is 500 cycles in the current state of the art; however, if a number of cycles greater than that is required, the electrolyte accommodating rate of a separator needs to be increased (as indicated by hypothetical line D). When this is the case, Point a shifts to Point a′, Point b to Point b′, and the range of separator thickness accordingly needs to be shifted.

### Third Embodiment

### Comparative Example Z1

A battery was fabricated in the same manner as in the foregoing embodiment except that the electrolyte accommodating rate was varied by changing the thickness and porosity of the separator and that the thickness of polyethylene (PE) film and the thickness of the polyamide (PA) film were changed.

The battery thus fabricated is hereinafter referred to as Comparative Battery Z1.

### Comparative Example Z2

A battery was fabricated in the same manner as in Comparative Example Z1 except that LiNi_{1/3}Mn_{1/3}Co_{1/3}O₂ was used as the positive electrode active material.

The battery thus fabricated is hereinafter referred to as Comparative Battery Z2.

### Comparative Example Z3

A battery was fabricated in the same manner as in Comparative Example Z1 except that Li₂Mn₂O₄ was used as the positive electrode active material.

The battery thus fabricated is hereinafter referred to as Comparative Battery Z3.

Experiment

A charge-discharge cycle test was conducted for Comparative Batteries Z1 to Z3 to examine the cycle life (whether electrolyte dry-out occurred and an approximate number of cycles at which cycle life degradation occurred due to the electrolyte dry-out) of each battery and development of a curl in the separator. The results are shown in Table 9 below. The charge-discharge conditions were identical to the conditions in Experiment 1 in the Preliminary Experiment discussed above.

TABLE 9

| | Comp. | Comp. Battery | Comp. |
|---|---|---|---|
| | Battery Z1 | Z2 | Battery Z3 |
| Positive electrode | LiCoO₂ | LiNi_{1/3}Mn_{1/3}Co_{1/3}O₂ | Li₂Mn₂O₄ |
| active material | | | |
| Negative electrode | Artificial | Artificial | Artificial |
| active material | graphite | graphite | graphite |
| Separator thickness | 11 | 11 | 11 |
| (μm) | | | |
| Porosity (%) | 65 | 65 | 65 |
| Electrolyte | 715 | 715 | 715 |
| accommodating rate | | | |
| (μm · %) | | | |
| Thickness of PE film | 5 | 5 | 5 |
| (μm) | | | |
| Thickness of PA film | 6 | 6 | 6 |
| (μm) | | | |
| Electrolyte dry-out | Yes | Yes | Yes |
| Curl | Yes | Yes | Yes |
| No. of cycles | 410 | 390 | 480 |
| (times) | | | |

Table 9 clearly demonstrates that Comparative Batteries Z1 and Z2, which employed a lithium cobalt oxide or a lithium-nickel composite oxide as the positive electrode active material, showed smaller numbers of cycles at which the dry-out occurred than Comparative Battery 3, which used a lithium manganese oxide. The reason is believed to be as follows.

In Comparative Batteries Z1 and Z2, which uses a lithium cobalt oxide or a lithium-nickel composite oxide as the positive electrode active material, the positive electrode deintercalates lithium ions during charge of the non-aqueous electrolyte battery, causing the crystals to expand. Consequently, the electrode plate tends to absorb a larger amount of electrolyte solution during charge than during discharge. On the other hand, the negative electrode intercalates lithium ions, causing the crystals to expand, and likewise the electrode plate tends to absorb a larger amount of electrolyte solution. Thus, both the positive and negative active materials expand during charge, absorbing a large amount of electrolyte solution, and the electrolyte solution absorbed at this time is that retained within the separator.

Here, the separator has a certain thickness because the separator is swelling when the electrolyte solution is contained therein, but by providing the electrolyte solution to the electrodes, it shrinks. Consequently, the expansion of the electrodes during charge is absorbed by the shrinkage of the separator to a certain extent. In other words, the separator functions as a buffer action of electrolyte solution retention. During discharge, both of the electrodes shrink and release the electrolyte solution, and the released electrolyte solution is absorbed by the separator again, causing the separator to swell; thereby the tension between the electrodes is ensured as in the case of the charge.

On the other hand, with Comparative Battery Z3, which used a lithium manganese oxide as the positive electrode active material, the positive electrode active material tends to shrink during charge of the battery, unlike the above-noted lithium cobalt oxide. Consequently, the expansion of the negative electrode can be alleviated to a certain degree by the shrinkage of the positive electrode, and the thickness increase or decrease of the battery as a whole becomes less. As a result, the load to the separator that functions as a buffer action of electrolyte solution retained is lowered.

As discussed above, a battery that uses a lithium cobalt oxide or a lithium-nickel composite oxide as positive electrode active material and a carbon material as the negative electrode active material has a strong tendency to easily cause the dry-out when the charge-discharge cycle is repeated. Therefore, when a separator according to the present invention is applied to such a battery that easily causes the dry-out, the advantages of the present invention will be exhibited more effectively.

The present invention is also applicable to large-sized batteries for, for example, in-vehicle power sources for electric automobiles or hybrid automobiles, as well as driving power sources for mobile information terminals such as mobile telephones, notebook computers, and PDAs.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority based on Japanese application No. 2004-093987 filed Mar. 29, 2004, which is incorporated herein by reference.

1. A battery separator, to be impregnated with a non-aqueous electrolyte and interposed between a positive electrode and a negative electrode, the battery separator comprising:
a plurality of layers of microporous films, at least one of the microporous films being film made of a polyolefin-based material, and at least one of the rest of the microporous film(s) being a film made of a material having a melting point of 200° C. or higher, and wherein a value obtained by multiplying the thickness (μm) of the battery separator by the porosity (%) of the battery separator is 792 μm·% or greater.

2. The battery separator according to claim 1, wherein the thickness of the film made of a material having a melting point of 200° C. or higher is 3 μm or greater but less than 10 μm.

3. The battery separator according to claim 1, wherein the thickness of the battery separator is 12 μm or greater.

4. The battery separator according to claim 3, wherein the thickness of the battery separator is 18 μm or less.

5. The battery separator according to claim 1, wherein the film made of a material having a melting point of 200° C. or higher is made of a polyamide or a polyimide.

6. The battery separator according to claim 5, wherein the polyamide is a para-aromatic polyamide.

7. The battery separator according to claim 1, wherein the film made of a polyolefin-based material is made of polyethylene.

8. The battery separator according to claim 1, the battery separator comprising a three-layer structure, in which one layer of the film made of a material having a melting point of 200° C. or higher is interposed between two layers of the film made of a polyolefin-based material.

9. A non-aqueous electrolyte secondary battery comprising a positive electrode having a positive electrode active material, a negative electrode having a negative electrode active material, and a battery separator interposed between the positive electrode and the negative electrode, wherein
the battery separator comprises a plurality of layers of microporous films, at least one of the microporous films comprising a film made of a polyolefin-based material, and at least one microporous film of the rest of the microporous film(s) comprising a film made of a material having a melting point of 200° C. or higher, and wherein a value obtained by multiplying the thickness (μm) of the battery separator by the porosity (%) of the battery separator is 792 μm·% or greater.

10. The non-aqueous electrolyte secondary battery according to claim 9, wherein the thickness of the film made of a material having a melting point of 200° C. or higher is 3 μm or greater but less than 10 μm.

11. The non-aqueous electrolyte secondary battery according to claim 9, wherein the thickness of the battery separator is 12 μm or greater.

12. The non-aqueous electrolyte secondary battery according to claim 11, wherein the thickness of the battery separator is 18 μm or less.

13. The non-aqueous electrolyte secondary battery according to claim 9, wherein the film made of a material having a melting point of 200° C. or higher is made of a polyamide or a polyimide.

14. The non-aqueous electrolyte secondary battery according to claim 13, wherein the polyamide is a para-aromatic polyamide.

15. The non-aqueous electrolyte secondary battery according to according to claim 9, wherein the film made of a polyolefin-based material is made of polyethylene.

16. The non-aqueous electrolyte secondary battery according to claim 9, wherein the battery separator comprises a three-layer structure, in which one layer of the film made of a material having a melting point of 200° C. or higher is interposed between two layers of the film made of a polyolefin-based material.

17. The non-aqueous electrolyte secondary battery according to claim 9, wherein the positive electrode active material contains a lithium cobalt oxide or a lithium-nickel composite oxide, and the negative electrode active material contains a carbon material.
